(19) United States
(12) Patent Application Publication
(10) Pub. No.: US 2004/0086001 A1
(43) Pub. Date: May 6, 2004

(54) Digital shaped gaussian monocycle pulses in ultra wideband communications

(76) Inventors: George J. Miao, Marlboro, NJ (US); Mark A. Clements, Lilburn, GA (US)

Correspondence Address: George J. Miao, 2 Inverness Drive, Marlboro, NJ, 07746, US

(21) Appl. No.: 10/283,732

(22) Filed: Oct. 30, 2002

(51) Int. Cl. H04B 1/10; H04J 3/06

(52) U.S. Cl. 370/516; 370/520

(57) ABSTRACT

Using the 1st derivative ultra-narrow Gaussian monocycle pulse passed through a digital shaping multi-band FIR filter may generate a digital ultra-narrow shaped Gaussian monocycle pulse. The spectrum output of the shaped Gaussian monocycle pulse directly meets the FCC's mask restrictions of the emission limits for indoor UWB system. The digital system of generating shaping Gaussian monocycle pulse may be implemented in the off-line operation to save the processing power. The pulse generator in the UWB transceiver has flexibility and scalability of selecting only one shaped pulse out of the data memory banks in which allocate all of the shaped Gaussian monocycle pulses with the different center frequencies. With a shaped pulse generator, an UWB transceiver does not need either a digital shaping transmission filter or an analog shaping transmission filter, with coupling to a D/A converter before or after, during a real-time operation.

### BACKGROUND

This invention relates generally to ultra wideband communications.

Ultra wideband communications (UWB) is true digital radio communication; completely unlike the radios we listen to and communicate every day. UWB is a wireless broadband communications technology fundamentally different from all other radio frequency (RF) communications. UWB achieves wireless broadband communication without using a RF carrier. Instead, UWB is a sequence of very short electrical pulses, billionths of a second long, which exist not on any particular frequency but on all frequencies simultaneously. UWB uses modulated pulses with 0.2 to one nanosecond (ns) in duration. The modulated pulse is usually assigned a digital representation of 0 or 1 to the transmitted and received pulse based on where the pulse is place in time. The key to turning the digital pulses into wireless broadband communication lies in the timing of the pulses. In order to hear the information in that code, a UWB receiver has to know the exact pulse sequence used by the transmitter.

Each pulse can exist simultaneously across an extensive band of frequencies if the distributed energy of the pulse at any given frequency exists in the noise floor. Therefore, UWB can co-exist with RF carrier-based communications with no discernable interference. This opens vast new communications with providing tremendous wireless frequency bandwidth to ease the growing bandwidth crunch, thereby permitting scarce spectrum resources to be used more efficiently.

The U.S. Federal Communications Commission (FCC) authorized limited commercial use of UWB devices on Feb. 14, 2002. The restrictions of FCC's emission require that commercial UWB devices should operate in radio spectrum in the frequency ranges from 3.1 GHz to 10.6 GHz. UWB communication devices should also satisfy by Part 15.209 limit, which sets emission limits for indoor UWB system, for the frequency band below 960 MHz. The FCC's masks of the emission limits are listed in Table 1 for indoor UWB system with the frequency bandwidth in terms of MHz and the magnitude in terms of dBm:

TABLE 1

| Frequency (MHz) | EIRP (dBm) |
|---|---|
| 0-960 | −41.3 |
| 960-1610 | −75.3 |
| 1610-1990 | −53.3 |
| 1990-3100 | −51.3 |
| 3100-10600 | −41.3 |
| Above 10600 | −51.3 |

UWB communication transceivers can transfer information data rates at 100 mega-bit per second (Mbps) to 1 giga-bit per second (Gbps), with sending repeated ultra-narrow pulse signals across distances as great as 10 meters, even up to 20 meters for indoor UWB system.

With transmitting repeated ultra-narrow pulse signals of less one nanosecond in the duration over the frequency bandwidth from 0 Hz to 10.6 GHz under the FCC's masks of the emission limits, the ultra-narrow pulses should be shaped before transmitting into air in such a way that the power spectrum magnitude of the ultra-narrow pulses must not violate the FCC's emission limits. So, a transmission filter in the UWB transmitter device may be needed when operating at a very high clock rate, and should provide pulse-shaping forms that can shape a digital sequence of ultra-narrow pulses for the UWB transmitter device to meet the FCC's restrictions of the emission limit for indoor UWB system. Such a transmission filter is referred to as the pulse shaping transmission filter for UWB communication devices. Therefore, UWB communication devices with a pulse-shaping transmission filter can operate without causing interference in the indoor environment by using the frequency spectrum occupied by existing radio services. Thereby, this permits spectrum resources to be reused more efficiently.

Based on the FCC's mask restrictions of the emission limits within the frequency bandwidth from 0 Hz to 10.6 GHz, this may lead to a digital pulse-shaping transmission filter having different filter-shaping forms, such as a multiband filter, or a two-band bandpass filter or a bandpass filter, and so on. It is a difficult problem to design and implement a digital pulse-shaping transmission filter operating in a very high-speed in real-time for an UWB communications transceiver for an indoor UWB system. As a result, this may complicate design and implementation with increasing cost for the UWB communication devices.

Thus, there is a continuing need for developing a digital shaping technique for an ultra-narrow pulse generator, without involving a transmission filter, in real-time operation to meet the FCC's restriction masks for emission limits on a UWB communications device for indoor UWB systems.

### SUMMARY

In accordance with one aspect, a digital system for shaping Gaussian monocycle pulse for an indoor UWB communication transceiver may contain a digital derivative Gaussian monocycle pulse with different center frequencies and sampling rates coupled to a digital multi-band shaping FIR filter in which the shaped Gaussian monocycle pulse can be stored in the data memory.

Other aspects are set forth in the accompanying detailed description and claims.

### BRIEF DESCRIPTION OF THE DRAWINGS

FIG. 1 is a block diagram of showing one embodiment of an UWB communication transceiver in accordance with the present invention;

FIG. 2 is a block diagram of showing a transmitter section of the UWB communication transceiver as shown in FIG. 1;

FIG. 3 is a block diagram of the receiver section of the UWB communication transceiver as shown in FIG. 1;

FIG. 4 is a graph of plotting a 1^{st} derivative Gaussian monocycle pulse at the center frequency of 1 GHz with amplitude in the Y-axis and time (ns) in the X-axis;

FIG. 5 is an overlay plot, including the FCC's masks of the emission limits and nine power spectrums of the 1^{st} derivative Gaussian monocycle pulses at different center frequencies with magnitude (dBm) in the Y-axis and frequency (GHz) in the X-axis;

FIG. 6 is a block diagram of showing a digital pulse shaping method for generating the shaped Gaussian monocycle pulses during the off-line operation;

FIG. 7 is an overlay plot including the FCC's masks of the emission limits, the power spectrum of the digital pulse shaping FIR filter, and the power spectrum output of the shaped 1^{st} derivative Gaussian monocycle pulse at the center frequency of 0.5 GHz with magnitude (dBm) in the Y-axis and frequency (GHz) in the X-axis;

FIG. 8 is a graph of plotting a discrete-time shaped 1^{st} derivative Gaussian monocycle pulse at the center frequency of 0.5 GHz with amplitude in the Y-axis and sample number in the X-axis;

FIG. 9 is a graph of plotting a time-domain shaped 1^{st} derivative Gaussian monocycle pulse at the center frequency of 0.5 GHz with amplitude in the Y-axis and time (ns) in the X-axis;

FIG. 10 is an overlay plot including the FCC's masks of the emission limits, the power spectrum of the digital pulse shaping FIR filter, and the power spectrum output of the shaped 1^{st} derivative Gaussian monocycle pulse at the center frequency of 0.75 GHz with magnitude (dBm) in the Y-axis and frequency (GHz) in the X-axis;

FIG. 11 is a graph of plotting a discrete-time shaped 1^{st} derivative Gaussian monocycle pulse at the center frequency of 0.75 GHz with amplitude in the Y-axis and sample number in the X-axis;

FIG. 12 is a graph of plotting a time-domain shaped 1^{st} derivative Gaussian monocycle pulse at the center frequency of 0.75 GHz with amplitude in the Y-axis and time (ns) in the X-axis;

FIG. 13 is an overlay plot including the FCC's masks of the emission limits, the power spectrum of the digital pulse shaping FIR filter, and the power spectrum output of the shaped 1^{st} derivative Gaussian monocycle pulse at the center frequency of 1 GHz with magnitude (dBm) in the Y-axis and frequency (GHz) in the X-axis;

FIG. 14 is a graph of plotting a discrete-time digital shaped 1^{st} derivative Gaussian monocycle pulse at the center frequency of 1 GHz with amplitude in the Y-axis and sample number (ns) in the X-axis;

FIG. 15 is a graph of plotting a time-domain shaped 1^{st} derivative Gaussian monocycle pulse at the center frequency of 1 GHz with amplitude in the Y-axis and time (ns) in the X-axis;

FIG. 16 is a block diagram of showing one embodiment of the present invention, including N data memory banks for pre-loading shaped Gaussian monocycle pulses, a pulse shaping bank selector, and a MUX unit with selectable switch;

FIG. 17 is a graph of plotting a set of time-domain shaped 1^{st} derivative Gaussian monocycle pulses at the center frequency of 1 GHz with amplitude in the Y-axis and sample number in the X-axis.

### DETAILED DESCRIPTION

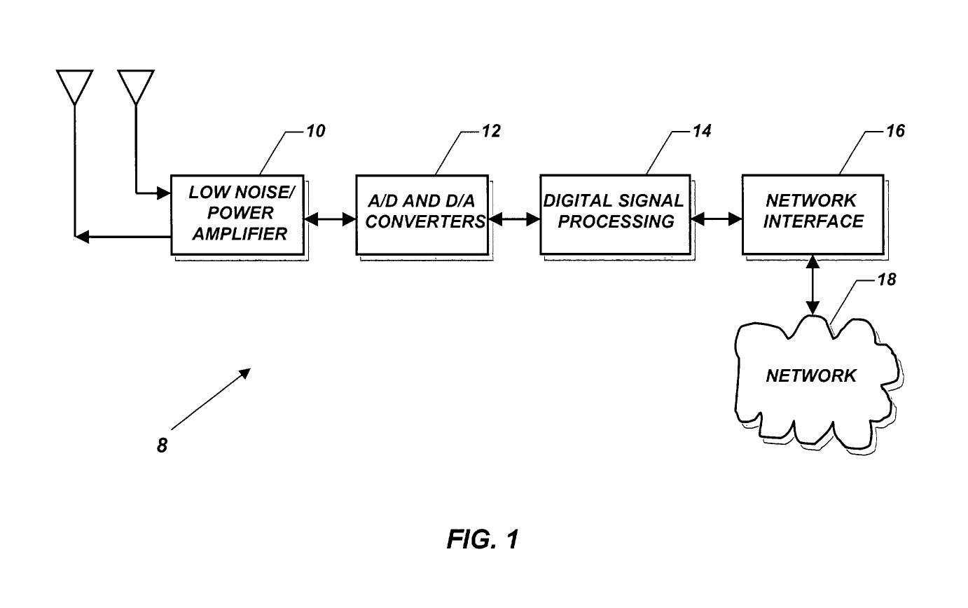

An UWB communication transceiver 8 in accordance with one embodiment of the present invention, shown in FIG. 1, includes a low-noise amplifier (LNA) and power amplifier (PA) section 10, which is coupled to transmitting and receiving antennas. The LNA and PA section 10 is also coupled to an analog-to-digital (A/D) and digital-to-analog (D/A) converter section 12. The A/D and D/A converter section 12 is coupled to the digital signal processing section 14. The digital signal processing section 14 is coupled to a network interface section 16. The network interface 16 interfaces with piconet network 18. In accordance with one embodiment of the present invention, the system 8 is referred to as an ultra wideband communication transceiver that both transmits and receives speech, audio, image, video, and data information by using a sequence of ultra-narrow pulses.

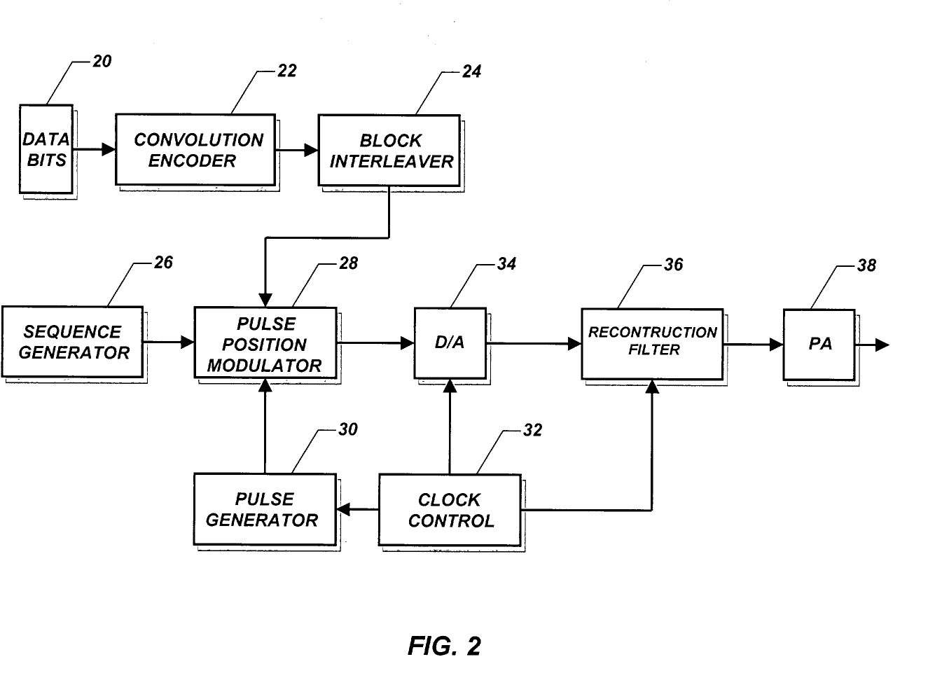

A dedicated physical channel showing the transmitter in the UWB communication transceiver, shown in FIG. 2, receives the user data bits 20, such as an information data rate at 100 Mbps. The information data bits 20 are passed through a ½-rate convolution encoder 22 that may produce the symbol data rate at 200 Msps by adding redundancy. The symbol data is then interleaved producing 200 Msps by the block interleaver 24. Thus, the output data symbols from the block interleaver 24 are modulated by the pulse position modulation (PPM) 28, which is able to produce several Gaussian-monocycle pulses based on one symbol data. The PPM technique 28 is used to assign a time-window, and shift the position of the Gaussian-monocycle pulses within the window in time. The sequence generator 26 is a time-hopping encoding sequence generator, which is coupled to the PPM section 28. Using the clock control 32 controls the pulse generator 30 to produce an ultra-narrow shaped Gaussian-monocycle pulse for the PPM technique 28. The power spectrum magnitude of a ultra-narrow shaped Gaussian-monocycle pulse produced by the pulse generator 30 is under the FCC's masks of the emission limits for indoor UWB system. The outputs of the ultra-narrow shaped Gaussian-monocycle pulses from the PPM 28 with time shifting are then passed through the D/A converter 34. The analog reconstruct filter 36 is used to reconstruct the analog ultra-narrow shaped Gaussian-monocycle pulses in the time-domain. Thus, the analog pulse signals from the output of the analog reconstruct filter 36 are passed the power amplifier (PA) 40 through an antenna into air.

The transmitter in an UWB communication transceiver, shown in FIG. 2, can also transmit the user data bits 20 with scalability, such as the data bit rate at 50 Mbps, 200 Mbps, 250 Mbps, 300 Mbps, 400 Mbps, 500 Mbps and even 1 Gbps, in the dedicated physical data channel. In these cases, the pulse generator 30 produces the corresponding pulse duration of the ultra-narrow shaped Gaussian-monocycle pulses, which are then modulated by the PPM 28, for the transmitter.

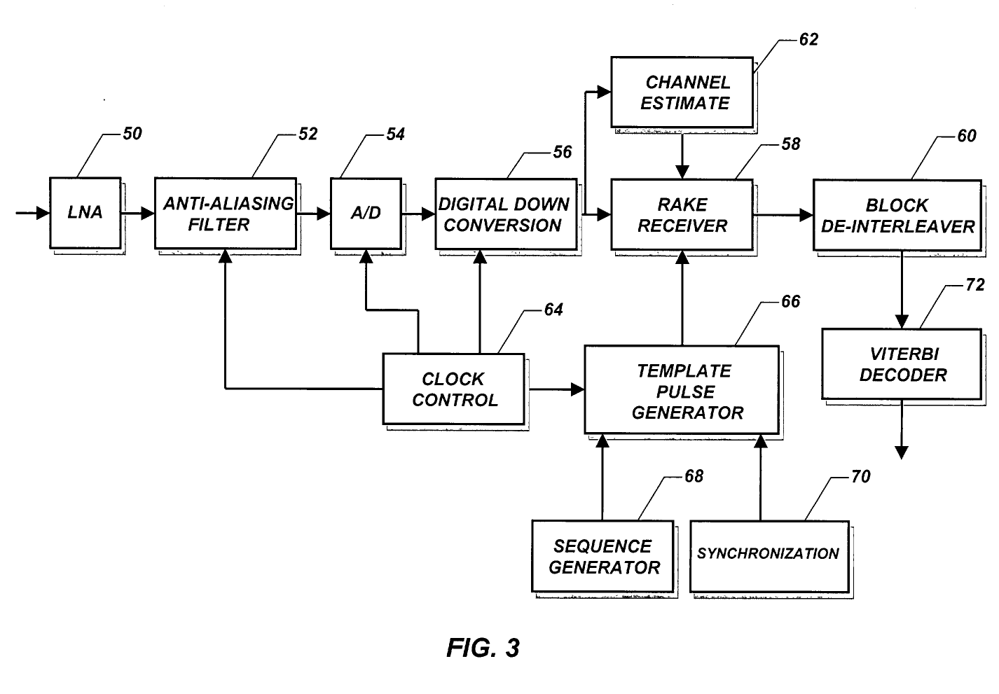

Referring to FIG. 3, which is the dedicated physical channel showing the receiver in an UWB communication transceiver, the LNA 50 receives the ultra-narrow Gaussian-monocycle pulses from an antenna. The analog signals are passed through the analog anti-aliasing filter 52. The bandlimited analog signals are then sampled and quantized by an A/D converter 54. The digital signals of the output of the A/D converter 54 are then shifted into the baseband signals by the digital down conversion (DDC) 56. Thus, the DDC 56 produces the digital data rate of 200 Gsps. The anti-aliasing filter 52, A/D converter 54, and DDC 56 are controlled by the clock control 64. The output data from the DDC 56 is used for the channel estimate 62, and the rake receiver 58. The channel estimate 62 is used to estimate the channel phase and frequency that are passed into the rake receiver 58. The rake receiver 58 calculates the correlation between the received ultra-narrow Gaussian-monocycle pulses and the template received pulses, which are generated by the template pulse generator 66, and performs coherent combination. The template pulse generator 66 is controlled by three functions: clock control 64, sequence generator 68, and synchronization 70. The output of the rake receiver 58 is passed through the block de-interleaver 60. Thus, the output data of the block de-interleaver 60 is used for the Viterbi decoder 72 to decode the encoded data and produce the information data bit rate at 100 Mbps.

The receiver in an UWB communication transceiver, shown in FIG. 3, can also receive the symbol data rate with scalability and produce the information data bits at 50 Mbps, 200 Mbps, 250 Mbps, 300 Mbps, 400 Mbps, and even 1 Gbps.

The time-domain representation of the 1^{st} derivative Gaussian monocycle pulse Pa (t) is given by

pₐ(t)=2\sqrt{e}Aπtf_{c}exp[−2(πtf_{c})²], (1)

where A is the peak amplitude of the Gaussian monocycle pulse and f_{c} is the pulse's center frequency. The corresponding frequency-domain Gaussian monocycle pulse Pₐ(f) can be obtained by

$${P}_{a} ( f ) = - \frac{j}{2} \sqrt{\frac{2 e}{π}} \frac{A}{{f}_{c}^{2}} f exp [ - \frac{1}{2} {( \frac{f}{{f}_{c}} )}^{2} ] . \qquad ( 2 )$$

Note that there exists a direct relationship between the Gaussian monocycle pulse's center frequency f_{c} and the pulse's duration T_{d}. The pulse's duration T_{d} defines the time interval between the Gaussian monocycle pulse's maximum and minimum amplitudes. In an UWB application, the duration T_{d} of a Gaussian monocycle pulse can be less than 1 nanosecond.

A time-domain 1^{st} derivative Gaussian monocycle pulse Pₐ(t) can be sampled at a rate of Fₛ=1/Tₛ samples per second by using an A/D converter. The sampled discrete-time 1^{st} derivative Gaussian monocycle pulse p[n] is then equal to the value of the time-domain pulse signal pₐ(t) at time nTₛ as follows:

p[n]=pₐ(nTₛ), −∞<n<∞, (3)

where the quantity Tₛ is known as the sampling period. Thus, the discrete-time 1^{st} derivative Gaussian monocycle pulse is obtained by,

p[n]=2\sqrt{e}AπnTₛf_{c}exp[−2(πnTₛf_{c})²], (4)

where Tₛ=1/Fₛ and f_{c} is the center frequency of the discrete-time Gaussian monocycle pulse.

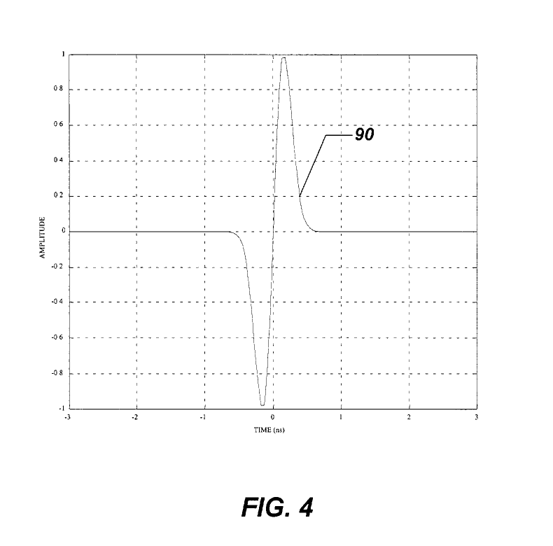

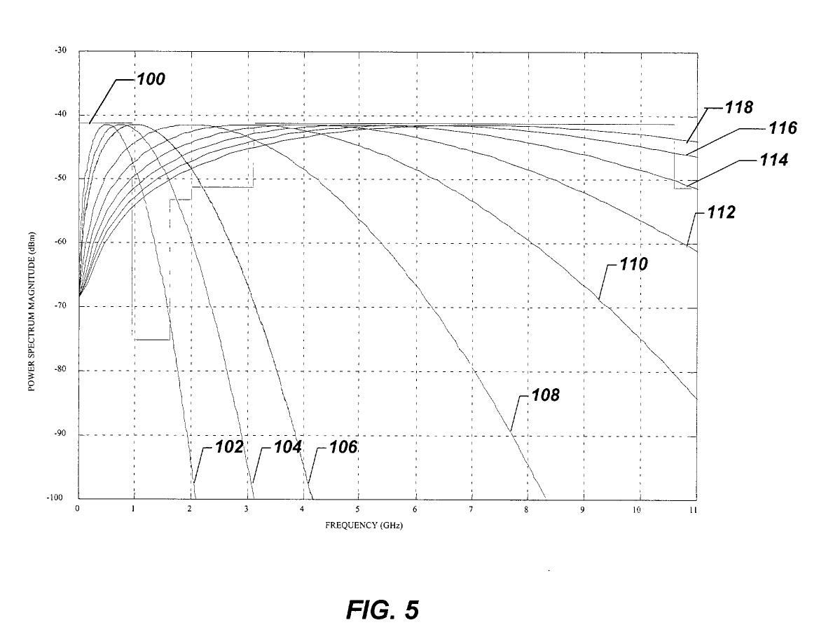

Referring to FIG. 4, the time-domain pulse 90 has the center frequency at 1 GHz that is generated by using the 1^{st} derivative Gaussian monocycle pulse based on the equation (1). Referring to FIG. 5, the corresponding frequency-domain Gaussian monocycle pulse 106 with the center frequency at 1 GHz is plotted by using the FFT spectrum. In addition, FIG. 5 also shows the spectrum outputs of other Gaussian monocycle pulses with the center frequencies at 0.5 GHz 102, 0.75 GHz 104, 2 GHz 108, 3 GHz 110, 4 GHz 112, 5 GHz 114, 6 GHz 116, and 7 GHz 118. The FCC's masks of the emission limits for indoor UWB systems are plotted with the brick-wall line 100. Note that all of the Gaussian monocycle pulses 102, 104, 106, 108, 110, 112, 114, 116, and 118 in frequency-domain, which are generated by using the equation (1), do violate the FCC's masks of the emission limits for indoor UWB systems. In other words, the Gaussian monocycle pulses, which are generated by using the equation (1) or by using the other theory formulas, cannot be directly used for the UWB device. In order to meet the FCC's mask of the emission limits for indoor UWB communication, the Gaussian monocycle pulses should be shaped before sending them into air.

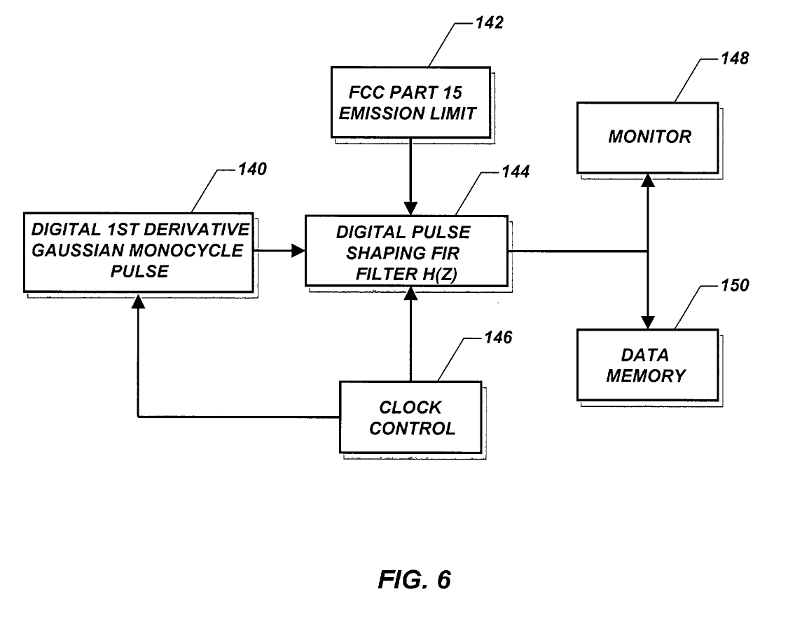

In one embodiment of the present invention is shown in FIG. 6. This subsystem is used to generate digital shaped Gaussian monocycle pulses that can directly meet the FCC's mask of the emission limits for indoor UWB system. This subsystem is referred to as the digital shaping pulse generator. The subsystem of the digital shaping pulse generator contains a digital 1^{st} derivative Gaussian monocycle pulse 140, the FCC's masks of the emission limit 142, a digital pulse shaping FIR filter H(z) 144, a clock control 146, a monitor 148, and data memory 150. The digital 1st derivative Gaussian monocycle pulse 140 that is produced by using the equation (4) is passed through the digital pulse shaping FIR filter H(z) 144 to generate the digital shaped Gaussian monocycle pulse. The digital pulse shaping FIR filter H(z) 144 is controlled by the FCC's masks of the emission limits 142 for indoor UWB system and by the clock control 146. The output of shaped Gaussian monocycle pulse from the digital pulse shaping FIR filter H(z) 144 is stored into the data memory 150. The shaped Gaussian monocycle pulse meets the FCC's masks of the emission limits and can be used for indoor UWB system for transmission directly. This subsystem implements the digital pulse shaping in the off-line operation. Thus, the computation complexity of shaping a Gaussian monocycle pulse is eliminated for an UWB communications transceiver.

In accordance with one embodiment of the present invention as shown in FIG. 6, the spectrum output of the digital pulse shaping FIR filter H(z) 144, which is referred to as a digital multi-band pulse shaping FIR filter, has the following characteristic properties of the frequency response:

1. The spectrum magnitude of the filter frequency response is −45.2≦|H(f)|≦−41.785 in dBm when 0≦f≦0.85 in GHz.

2. The spectrum magnitude of the filter frequency response is |H(f)|≦−76 in dBm when 0.87≦f≦1.735 in GHz.

3. The spectrum magnitude of the filter frequency response is −53.837≦|H(f)|≦−53.836 in dBm when f=2.0 in GHz.

4. The spectrum magnitude of the filter frequency response is −54.342≦|H(f)|≦−51.764 in dBm when 2.3≦f≦3.25 in GHz.

5. The spectrum magnitude of the filter frequency response is −42.474≦|H(f)|≦−41.690 in dBm when 3.30≦f≦10.41 in GHz.

6. The spectrum magnitudes of the filter frequency response are |H(f)|≦−52 and |H(f)|=−100 in dBm when 10.6≦f<11 and f=11 in GHz, respectively.

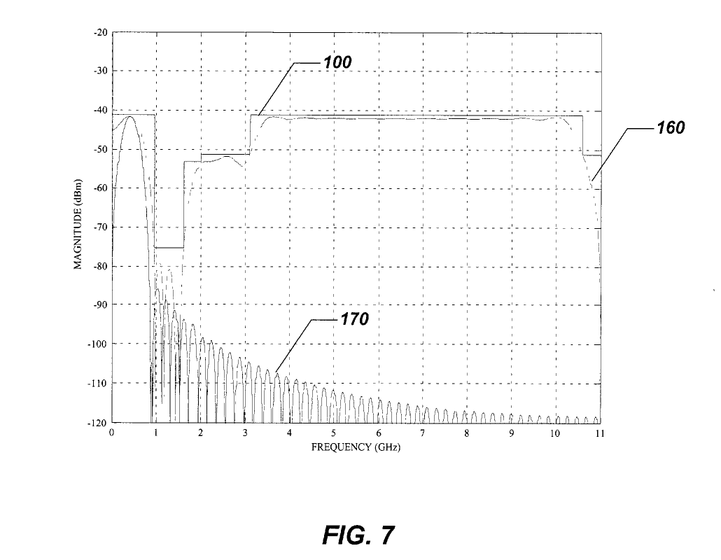

Referring to FIG. 7, the spectrum output 160 of the digital pulse shaping FIR filter H(z) 144 is plotted along with the FCC's masks of the emission limits 100, and the shaped Gaussian monocycle pulse 170 at the center frequency of 0.5 GHz. It is clearly that the shaped Gaussian monocycle pulse 170 is under the FCC's masks of the emission limits.

The impulse response h[n] of the digital pulse shaping FIR filter H(z) 144 is an even and symmetric with sixty filter coefficients, and a linear phase. Table 2 lists sixty filter coefficients of the digital pulse shaping FIR filter H(z) 144.

The digital pulse shaping FIR filter H(z) 144 in FIG. 6 may be designed using the least square methods. Other filter techniques such as equiripple approximations, and windowing methods may also be used.

TABLE 2

| Taps | Value | Taps | Value |
|---|---|---|---|
| h(−1), h(1) | 1.0901878736005247e-004 | h(−16), h(16) | −3.1378870024120105e-006 |
| h(−2), h(2) | −8.3500570759751009e-005 | h(−17), h(17) | −5.1367770579543416e-006 |
| h(−3), h(3) | 1.8372619168959620e-005 | h(−18), h(18) | 1.5833350973151792e-006 |
| h(−4), h(4) | −1.0734500768445837e-005 | h(−19), h(19) | −1.6482962854063237e-006 |
| h(−5), h(5) | 3.3173818217076831e-005 | h(−20), h(20) | 9.1406581808267778e-007 |
| h(−6), h(6) | 9.1624092904964326e-006 | h(−21), h(21) | −5.2346442307169757e-006 |
| h(−7), h(7) | 1.9971958684341682e-005 | h(−22), h(22) | −3.6263488055064421e-006 |
| h(−8), h(8) | 1.1172610696348669e-006 | h(−23), h(23) | −5.9539155182765042e-006 |
| hL−9), h(9) | 7.1966811911751775e-006 | h(−24), h(24) | −2.0720314692193031e-006 |
| h(−10), h(10) | 3.6797309877609960e-006 | h(−25), h(25) | −1.8269320649359194e-006 |
| h(−11), h(11) | 9.4083737703487005e-006 | h(−26), h(26) | −8.5935087630771085e-007 |
| h(−12), h(12) | 8.8321228325395951e-006 | h(−27), h(27) | −2.0631422036792858e-006 |
| h(−13), h(13) | 4.7048163658275057e-006 | h(−28), h(28) | −4.0728936277686056e-006 |
| h(−14), h(14) | 1.3007412252348223e-006 | h(−29), h(29) | −2.8503759925306026e-006 |
| h(−15), h(15) | −5.7552689441871551e-006 | h(−30), h(30) | −3.1586473047877383e-006 |

For a digital pulse shaping FIR filter system, the FIR filter performs a weighted average on M samples,

$$y [ n ] = {\sum }_{k = 0}^{M - 1} h [ k ] p [ n - k ] , \qquad ( 5 )$$

where h[n] is the impulse response of the digital pulse shaping FIR filter H(z), p[n] is the digital 1^{st} derivative Gaussian monocycle pulse or other forms of the Gaussian monocycle pulse, and y[n] is the shaped Gaussian monocycle 10 pulse that must meet the FCC's masks of the emission limits. Equation (5) may be implemented by a direct-form structure or a cascade-form structure. In addition, the pulse shaping FIR filter in equation (3) may be implemented by a symmetry-form structure since all of the pulse-shaping FIR filter designed are an even and symmetric,

$$y [ n ] = {\sum }_{k = 0}^{( M - 1 ) / 2} h [ k ] ( p [ n - k ] + p [ n - M + k ] ) . \qquad ( 6 )$$

In this case, equation (6) shows the implementation structure with (M+1)/2 multipliers rather than the M multipliers of the direct-form and cascade-form structures.

FIG. 7 demonstrates the result of one implementation of the present invention showing an overlay plot, including the FCC's masks of the emission limits 100, the power spectrum output of the digital pulse shaping FIR filter 160, and the power spectrum output of the shaped 1^{st} derivative Gaussian monocycle pulse at the center frequency of 0.5 GHz 170 with magnitude (dBm) in the Y-axis and frequency (GHz) in the X-axis. It is clear that the shaped 1^{st} derivative Gaussian monocycle pulse 170 meets the FCC's mask restriction on the emission limits.

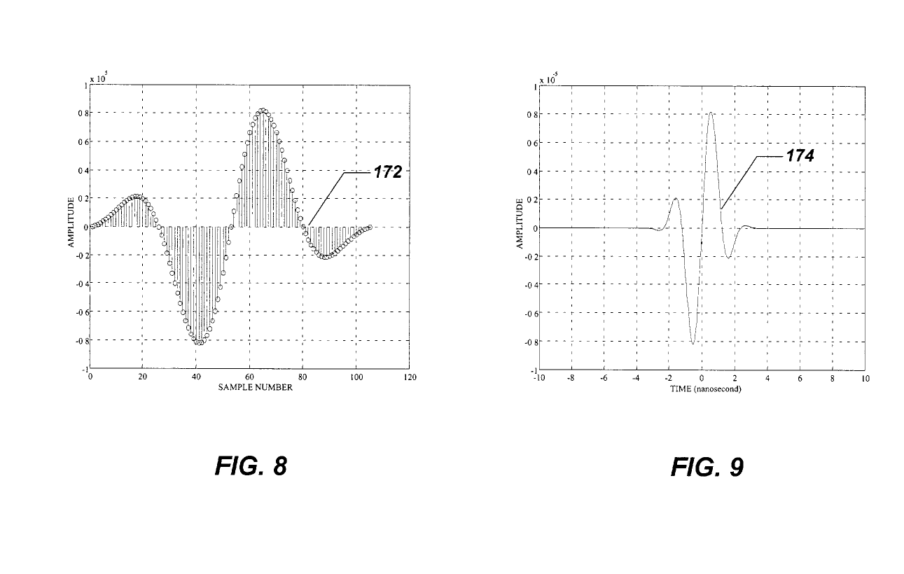

In accordance with one embodiment of the result of the present invention in FIG. 7, the discrete-time shaped Gaussian monocycle pulse 172 that meets the FCC's masks of the emission limits is plotted in FIG. 8 with amplitude in the Y-axis and sample number in the X-axis. The corresponding time-domain shaped Gaussian monocycle pulse 174 is shown in FIG. 9. Table 3 lists all of the discrete-time value of the shaped Gaussian monocycle pulse 172 in FIG. 8. There are 105 discrete-time values for the shaped Gaussian monocycle pulse 172 as follows:

TABLE 3

| p [n] | p [n] | p [n] |
|---|---|---|
| −6.3708444260307961e-09 | −6.6235965107315161e-06 | 6.0352577171604055e-06 |
| 6.5822424292531069e-08 | −7.1388009264585713e-06 | 5.3898633894731424e-06 |
| 1.5410039752216047e-07 | −7.5656996073985165e-06 | 4.7038913655054956e-06 |
| 2.5887399305031282e-07 | −7.8905374133093281e-06 | 3.9937396295815094e-06 |
| 3.8001142066481153e-07 | −8.1014509505036462e-06 | 3.2752979470946827e-06 |
| 5.1675055902126273e-07 | −8.1888796686741493e-06 | 2.5635804363181410e-06 |
| 6.6762760223409930e-07 | −8.1458896851054158e-06 | 1.8724201850105186e-06 |
| 8.3042651480909271e-07 | −7.9684001006303718e-06 | 1.2142208377857849e-06 |
| 1.0021521750539123e-06 | −7.6553149260049352e-06 | 5.9975797370632232e-07 |
| 1.1790284309094225e-06 | −7.2085739267154552e-06 | 3.8024665979731366e-08 |
| 1.3565210841599322e-06 | −6.6331396508599702e-06 | −4.6388053550886211e-07 |
| 1.5293853846589375e-06 | −5.9369345451675280e-06 | −9.0082070365529650e-07 |
| 1.6917380340333366e-06 | −5.1307328244231848e-06 | −1.2696373078418159e-06 |
| 1.8371547352431332e-06 | −4.2280002691992815e-06 | −1.5691108301704271e-06 |
| 1.9587954657548141e-06 | −3.2446660606764347e-06 | −1.7998617501267696e-06 |
| 2.0495602317299176e-06 | −2.1988082224331375e-06 | −1.9641930087958144e-06 |
| 2.1022774625666718e-06 | −1.1102402368063813e-06 | −2.0658807071475112e-06 |
| 2.1099250803647000e-06 | −7.8747594315048235e-022 | −2.1099250803646996e-06 |
| 2.0658807071475112e-06 | 1.1102402368063824e-06 | −2.1022774625666713e-06 |
| 1.9641930087958131e-06 | 2.1988082224331366e-06 | −2.0495602317299180e-06 |
| 1.7998617501267685e-06 | 3.2446660606764356e-06 | −1.9587954657548141e-06 |
| 1.5691108301704275e-06 | 4.2280002691992857e-06 | −1.8371547352431332e-06 |
| 1.2696373078418148e-06 | 5.1307328244231814e-06 | −1.6917380340333370e-06 |
| 9.0082070365529661e-07 | 5.9369345451675238e-06 | −1.5293853846589379e-06 |
| 4.6388053550886217e-07 | 6.6331396508599728e-06 | −1.3565210841599316e-06 |
| −3.8024665979731141e-08 | 7.2085739267154552e-06 | −1.1790284309094227e-06 |
| −5.9975797370632169e-07 | 7.6553149260049419e-06 | −1.0021521750539119e-06 |
| −1.2142208377857845e-06 | 7.9684001006303735e-06 | −8.3042651480909271e-07 |
| −1.8724201850105188e-06 | 8.1458896851054124e-06 | −6.6762760223409888e-07 |
| −2.5635804363181418e-06 | 8.1888796686741459e-06 | −5.1675055902126294e-07 |
| −3.2752979470946797e-06 | 8.1014509505036428e-06 | −3.8001142066481159e-07 |
| −3.9937396295815110e-06 | 7.8905374133093332e-06 | −2.5887399305031277e-07 |
| −4.7038913655054956e-06 | 7.5656996073985165e-06 | −1.5410039752216044e-07 |
| −5.3898633894731407e-06 | 7.1388009264585730e-06 | −6.5822424292531055e-08 |
| −6.0352577171604063e-06 | 6.6235965107315161e-06 | 6.3708444260308425e-09 |

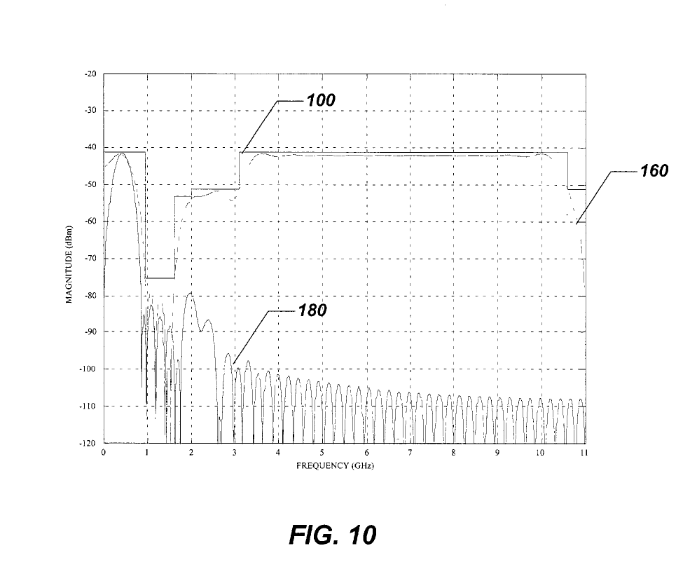

FIG. 10 demonstrates the result of another implementation of the present invention showing an overlay plot, including the FCC's masks of the emission limits 100, the power spectrum output of the digital pulse shaping FIR filter 160, and the power spectrum output of the shaped 1^{st} derivative Gaussian monocycle pulse at the center frequency of 0.75 GHz 180 with magnitude (dBm) in the Y-axis and frequency (GHz) in the X-axis. It is clear that the shaped 1^{st} derivative Gaussian monocycle pulse 180 meets the FCC's mask restrictions on the emission limits.

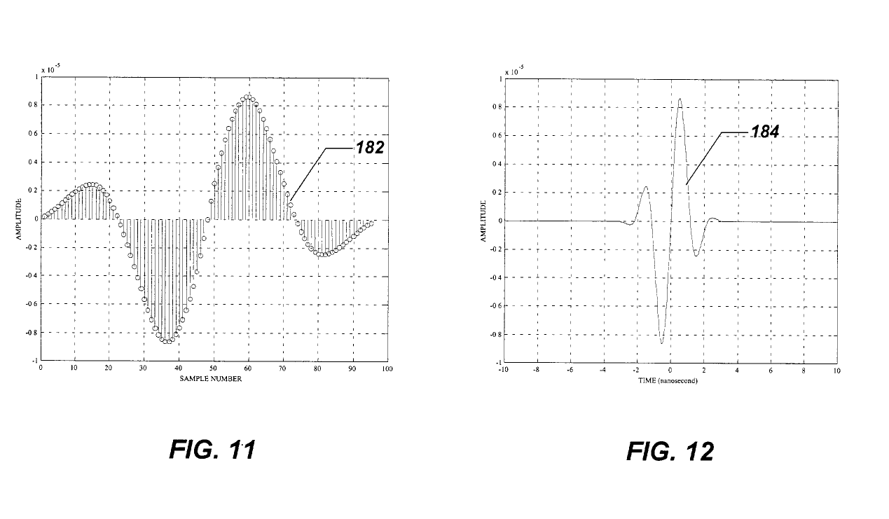

In accordance with one embodiment of the result of the present invention in FIG. 10, the discrete-time shaped Gaussian monocycle pulse 182 that meets the FCC's masks on the emission limits is plotted in FIG. 11 with amplitude in the Y-axis and sample number in the X-axis. The corresponding time-domain shaped Gaussian monocycle pulse 184 is shown in FIG. 12. Table 4 lists all of the discrete-time values of the shaped Gaussian monocycle pulse 182 in FIG. 11. There are 95 discrete-time values for the shaped Gaussian monocycle pulse 182 as follows:

TABLE 4

| p [n] | p [n] | p [n] |
|---|---|---|
| 1.9581082181598908e-007 | −7.6442820674868501e-006 | 6.3792161051083916e-006 |
| 3.4464206442118000e-007 | −8.1165483805185272e-006 | 5.6474789964959956e-006 |
| 5.1657652850467159e-007 | −8.4433694806166956e-006 | 4.8831330073729417e-006 |
| 7.0822277854377608e-007 | −8.6055860676477487e-006 | 4.1033486211782507e-006 |
| 9.1460455029775377e-007 | −8.5962456577483755e-006 | 3.3205693094248539e-006 |
| 1.1297213450429416e-006 | −8.4207436827782627e-006 | 2.5453103541046798e-006 |
| 1.3472229740052600e-006 | −8.0938858827629971e-006 | 1.7883309648286263e-006 |
| 1.5609765168998875e-006 | −7.6346894550259873e-006 | 1.0613873038458280e-006 |
| 1.7653399071076690e-006 | −7.0601917623849317e-006 | 3.7681580796540288e-007 |
| 1.9550424764924894e-006 | −6.3800083156609285e-006 | −2.5327626268174410e-007 |
| 2.1246810856357546e-006 | −5.5938277715870198e-006 | −8.1763669756150401e-007 |
| 2.2679619471711780e-006 | −4.6937937678230659e-006 | −1.3062986011464452e-006 |
| 2.3769476665306043e-006 | −3.6721098961259837e-006 | −1.7111675041936043e-006 |
| 2.4416678137814403e-006 | −2.5314519342493023e-006 | −2.0269908659516407e-006 |
| 2.4504375283069944e-006 | −1.2933968745482311e-006 | −2.2524834747347219e-006 |
| 2.3910292842956789e-006 | 6.1211365328924048e-022 | −2.3910292842956789e-006 |
| 2.2524834747347198e-006 | 1.2933968745482301e-006 | −2.4504375283069949e-006 |
| 2.0269908659516416e-006 | 2.5314519342493019e-006 | −2.4416678137814407e-006 |
| 1.7111675041936049e-006 | 3.6721098961259871e-006 | −2.3769476665306051e-006 |
| 1.3062986011464452e-006 | 4.6937937678230676e-006 | −2.2679619471711784e-006 |
| 8.1763669756150358e-007 | 5.5938277715870165e-006 | −2.1246810856357559e-006 |
| 2.5327626268174373e-007 | 6.3800083156609327e-006 | −1.9550424764924902e-006 |
| −3.7681580796540410e-007 | 7.0601917623849267e-006 | −1.7653399071076686e-006 |
| −1.0613873038458286e-006 | 7.6346894550259822e-006 | −1.5609765168998871e-006 |
| −1.7883309648286258e-006 | 8.0938858827630005e-006 | −1.3472229740052598e-006 |
| −2.5453103541046807e-006 | 8.4207436827782593e-006 | −1.1297213450429410e-006 |
| −3.3205693094248531e-006 | 8.5962456577483806e-006 | −9.1460455029775441e-007 |
| −4.1033486211782516e-006 | 8.6055860676477504e-006 | −7.0822277854377619e-007 |
| −4.8831330073729451e-006 | 8.4433694806166922e-006 | −5.1657652850467138e-007 |
| −5.6474789964959939e-006 | 8.1165483805185289e-006 | −3.4464206442118011e-007 |
| −6.3792161051083899e-006 | 7.6442820674868433e-006 | −1.9581082181598915e-007 |
| −7.0546463544423668e-006 | 7.0546463544423668e-006 | |

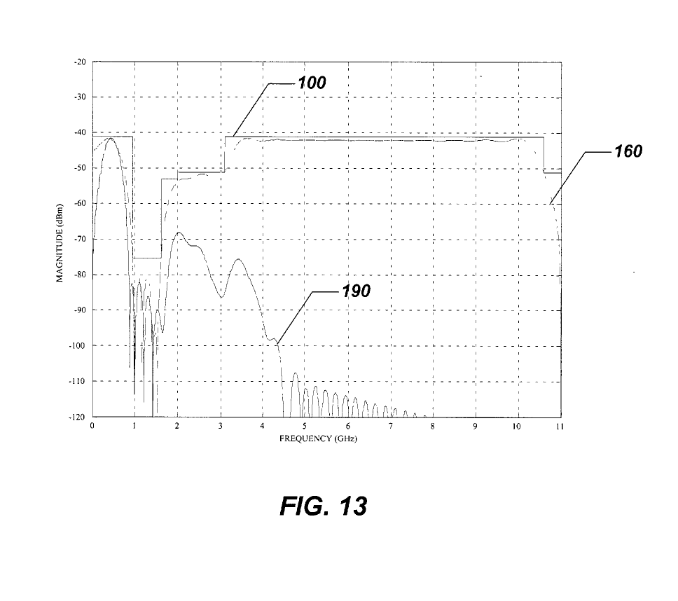

FIG. 13 demonstrates the result of another implementation of the present invention showing an overlay plot, including the FCC's mask of the emission limits 100, the power spectrum output of the digital pulse shaping FIR filter 160, and the power spectrum output of the shaped 1^{st} derivative Gaussian monocycle pulse at the center frequency of 1 GHz 190 with magnitude (dBm) in the Y-axis and frequency (GHz) in the X-axis. It is clear that the shaped 1^{st} derivative Gaussian monocycle pulse 190 meets the FCC's mask restrictions on the emission limits.

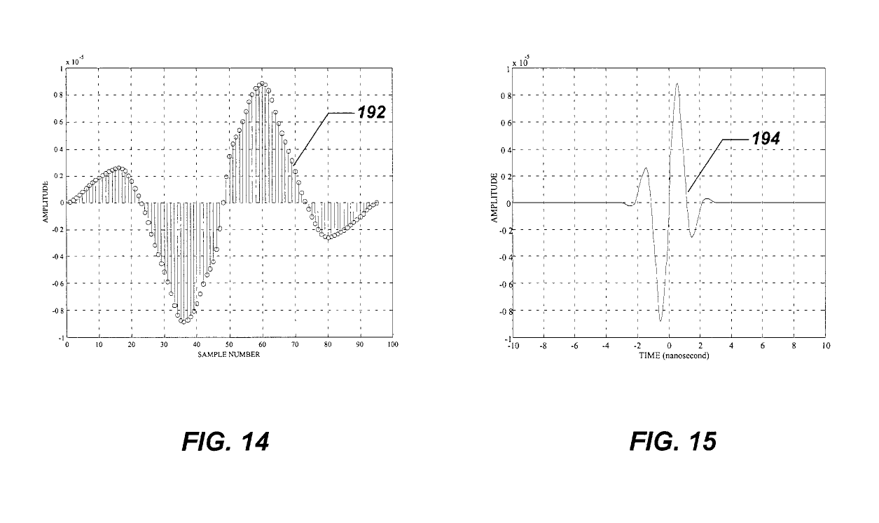

In accordance with one embodiment of the result of the present invention in FIG. 13, the discrete-time shaped Gaussian monocycle pulse 192 that meet the FCC's masks of the emission limits is plotted in FIG. 14 with amplitude in the Y-axis and sample number in the X-axis. The corresponding time-domain shaped Gaussian monocycle pulse 194 is shown in FIG. 14. Table 5 lists all of the discrete-time value of the shaped Gaussian monocycle pulse 192. There are 95 discrete-time values for the shaped Gaussian monocycle pulse 192 as follows:

TABLE 5

| p [n] | p [n] | p [n] |
|---|---|---|
| 4.3282611930007768e-008 | −7.6190593293262803e-006 | 5.8928877868221534e-006 |
| 1.8171842429555803e-007 | −8.3365764808733691e-006 | 5.1542859010102613e-006 |
| 3.6050657727541378e-007 | −8.7596051195582078e-006 | 4.5087649400993487e-006 |
| 5.7325937564527954e-007 | −8.8638170473108453e-006 | 3.8594016841021374e-006 |
| 8.0582428797319510e-007 | −8.7299047257939267e-006 | 3.1266844324348531e-006 |
| 1.0423104093771271e-006 | −8.4512291231199191e-006 | 2.3112890377837394e-006 |
| 1.2714889073863583e-006 | −8.0503403360081845e-006 | 1.4848731823243095e-006 |
| 1.4889142847697816e-006 | −7.4909129569773258e-006 | 7.2790184088457467e-007 |
| 1.6936737462811121e-006 | −6.7755100862835817e-006 | 7.2085552466221139e-008 |
| 1.8835879980726082e-006 | −6.0172381380770519e-006 | −5.0744433167037013e-007 |
| 2.0542588079448942e-006 | −5.3775421071364317e-006 | −1.0518779892997211e-006 |
| 2.2032295887055578e-006 | −4.8947018279211719e-006 | −1.5708381254124178e-006 |
| 2.3338670475897033e-006 | −4.3688101782286615e-006 | −2.0277780793208469e-006 |
| 2.4513650449639156e-006 | −3.4582569159447578e-006 | −2.3667336931035378e-006 |
| 2.5497972142680588e-006 | −1.9537324584649155e-006 | −2.5539643682755105e-006 |
| 2.6001740448622969e-006 | −1.2374621963793294e-021 | −2.6001740448622990e-006 |
| 2.5539643682755110e-006 | 1.9537324584649163e-006 | −2.5497972142680597e-006 |
| 2.3667336931035374e-006 | 3.4582569159447595e-006 | −2.4513650449639156e-006 |
| 2.0277780793208464e-006 | 4.3688101782286649e-006 | −2.3338670475897037e-006 |
| 1.5708381254124193e-006 | 4.8947018279211694e-006 | −2.2032295887055570e-006 |
| 1.0518779892997194e-006 | 5.3775421071364309e-006 | −2.0542588079448950e-006 |
| 5.0744433167037066e-007 | 6.0172381380770527e-006 | −1.8835879980726084e-006 |
| −7.2085552466220729e-008 | 6.7755100862835834e-006 | −1.6936737462811118e-006 |
| −7.2790184088457435e-007 | 7.4909129569773283e-006 | −1.4889142847697814e-006 |
| −1.4848731823243099e-006 | 8.0503403360081845e-006 | −1.2714889073863583e-006 |
| −2.3112890377837394e-006 | 8.4512291231199191e-006 | −1.0423104093771271e-006 |
| −3.1266844324348548e-006 | 8.7299047257939216e-006 | −8.0582428797319510e-007 |
| −3.8594016841021340e-006 | 8.8638170473108520e-006 | −5.7325937564527975e-007 |
| −4.5087649400993470e-006 | 8.7596051195582095e-006 | −3.6050657727541389e-007 |
| −5.1542859010102630e-006 | 8.3365764808733691e-006 | −1.8171842429555813e-007 |
| −5.8928877868221508e-006 | 7.6190593293262836e-006 | −4.3282611930007848e-008 |
| −6.7470336060866389e-006 | 6.7470336060866363e-006 | |

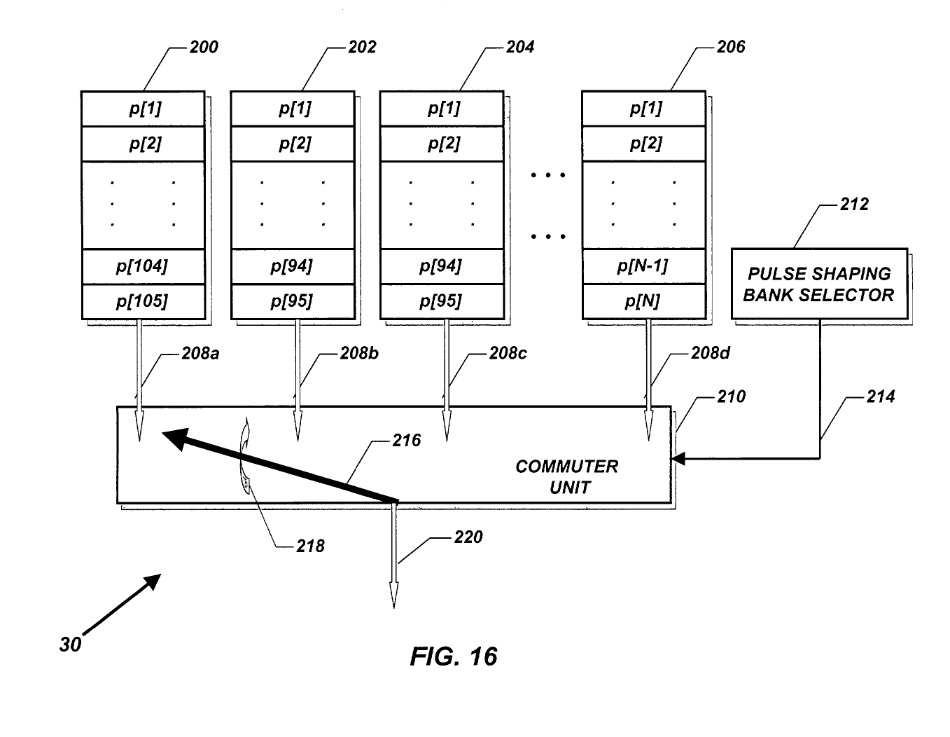

In accordance with another embodiment of the present invention, shown in FIG. 16, the shaped Gaussian monocycle pulses at the center frequencies of 0.5 GHz 172 in FIG. 8, 0.75 GHz 182 in FIG. 11, and 1 GHz 192 in FIG. 14 are stored into the data memory banks 200, 202, and 204, respectively. This architecture shown in FIG. 16 contains N data memory banks and is able to store up to N shaped Gaussian monocycle pulses with different N center frequencies. The selectable COMMUTER unit 210 contains the switch functions 216 and 218 that are able to connect one of any data memory banks 200, 202, 204, 206, and so no. The pulse shaping bank selector 212 controls the switch functions 216 and 218 in the selectable COMMUTER unit 210. So, only one shaped Gaussian monocycle pulse in the data memory banks is selected for the pulse generator 30 in FIG. 2.

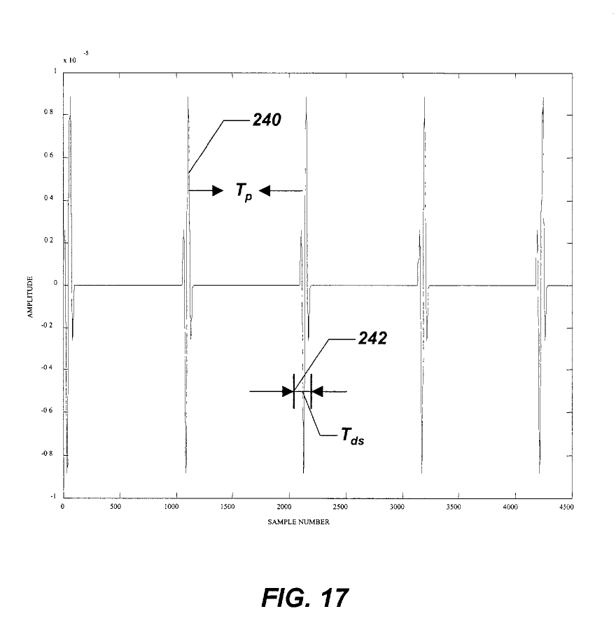

Referring to the output result of shaped Gaussian monocycle pulses in the present invention shown in FIG. 17, this sequence of the shaped pulse train 240 in FIG. 17 is the output of the reconstructing filter 36 in FIG. 2. The duration T_{ds} 242 of the shaped Gaussian monocycle pulse is much less than the duration Tₚ between the shaped pulse to pulse in FIG. 17. So, the D/A converter 34 in FIG. 2 is only needed to operate during the duration T_{ds} of the shaped pulse to save the processing power.

While the present inventions have been described with respect to a limited number of embodiments, those skilled in the art will appreciate numerous modifications and variations therefrom. It is intended that the appended claims cover all such modifications and variations as fall within the true spirit and scope of these present inventions.

What is claimed is:

1. A digital system of shaping a Gaussian monocycle pulse comprising:
a digital derivative Gaussian monocycle pulse with the different center frequencies and sampling rates coupled to a digital multi-band shaping FIR filter in which the shaped Gaussian monocycle pulse can be stored into the data memory.

2. The transceiver of claim 1 wherein said a digital shaping Gaussian monocycle pulse system can produce the shaped Gaussian monocycle pulses for a pulse generator in such a way that meet the FCC's masks of the emission limits directly.

3. The transceiver of claim 1 wherein said a digital shaping Gaussian monocycle pulse system may implement in the off-line operation for eliminating the computation complexity in an UWB device.

4. The transceiver of claim 1 wherein said a digital shaping FIR filter may be a multi-band FIR filter, or other-form FIR filter that meet the FCC's mask restrictions of the emission limits.

5. The transceiver of claim 4 wherein said other-form digital shaping FIR filter may be a two-band bandpass FIR filter, one-band bandpass FIR filter, or Gaussian-form FIR filter that meets the FCC's mask restrictions of the emission limits.

6. The transceiver of claim 3 wherein said an UWB communication transceiver may not have either a digital shaping transmission filter or an analog shaping transmission filter, with coupling to an D/A converter before or after, in the real-time operation.

7. The transceiver of claim 1 wherein said a data memory allocates a shaped Gaussian monocycle pulse with transacting to cover entire shaped pulse only.

8. The transceiver of claim 7 wherein said a transacted digital shaped Gaussian monocycle pulse has an odd number in samples with approximate zero value at index of the median sample, odd symmetric in samples, and odd symmetric peak in amplitudes.

9. A shaped pulse generator comprising:
data memory banks, selectable COMMUTER unit with a switch, and pulse shaping bank selector.

10. The transceiver of claim 9 wherein said N digital shaped Gaussian monocycle pulses with different center frequencies are stored into the N data memory banks, respectively.

11. The transceiver of claim 9 wherein said the selectable COMMUTER unit with a switch selects only one digital shaped Gaussian monocycle from the data memory banks for an UWB operation.

12. The transceiver of claim 11 wherein said the switch function in the COMMUTER unit is controlled by the pulse shaping bank selector.

13. The transceiver of claim 9 wherein said a shaped pulse generator can be implemented either in a hardware or in a software.

14. The D/A converter in the UWB transceiver needs to only operate on the duration of the shaped Gaussian monocycle pulse to save the processing power.

15. The transceiver of claim 14 wherein said a duration of the shaped Gaussian monocycle pulse can be determined by the sample numbers of a shaped Gaussian monocycle pulse in a data memory bank for operating the D/A converter.
